(19) United States
(12) Patent Application Publication
(10) Pub. No.: US 2007/0228994 A1
(43) Pub. Date: Oct. 4, 2007

(54) DRIVING CIRCUIT AND METHOD FOR FLUORESCENT LAMP

(75) Inventors: Jin-Chyuan Hung, Hsin-chu (TW); Qiu-Kai Huang, Hsin-Chu (TW); Jia-Ping Ying, Hsin-Chu (TW); Yui-Shin Fran, Hsin-Chu (TW); Chang-Chun Hsiao, Hsin-Chu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Optoelectronics, Inc., Hsin-Chu (TW)

(21) Appl. No.: 11/550,029

(22) Filed: Oct. 17, 2006

(30) Foreign Application Priority Data
Apr. 4, 2006 (TW) 95112055

(51) Int. Cl. H05B 41/24

(52) U.S. Cl. 315/247

(57) ABSTRACT

Disclosed is a driving circuit and method for a fluorescent lamp. The driving circuit comprises a power factor correction (PFC) stage, a startup stage, an isolation stage, a square-wave driving stage and an output stage. The PFC stage receives and converts an input alternating current (AC) voltage into a direct current (DC) voltage. The startup stage receives the DC voltage and adjusts the DC voltage into an operating voltage. The startup stage is connected in parallel with the square-wave driving stage. The square-wave driving stage is connected to the isolation stage and converts the operating voltage into a boosted square-wave voltage, and the output stage receives the boosted square-wave voltage to ignite the fluorescent lamp. As such, the fluorescent lamp may be rapidly and properly ignited.

### FIELD OF THE INVENTION

The present invention relates to a fluorescent lamp. More particularly, the present invention relates to a driving circuit and method for a fluorescent lamp.

### BACKGROUND OF THE INVENTION

Recently, liquid crystal display (LCD) has achieved a significant improvement and is anticipated to replace the cathode ray tube (CRT) as the mainstream display product. The LCD is a display requiring a backlight source for displaying images. To satisfy the demands for the LCD of various specifications, miscellaneous backlight sources are developed rapidly. Generally, the backlight sources may be categorized into mercury containing cool cathode fluorescent lamp (CCFL), the mercury free fluorescent lamp, light-emitting diode (LED), mercury-containing flat fluorescent lamp (FFL) and mercury-free flat fluorescent lamp (FFL). Among them, the CCFL based backlight source is the most widely used one.

In operation, ions or excited atoms are generated by exciting gas in the fluorescent lamp and then the exciting molecules come back to their stable states. At the same time, photons with specific frequency, i.e. ultraviolet (UV) light, are emitted. When the emitted UV light excites the phosphors coated within the lamp body, the visible light can be generated. To generate the exciting gas, the high voltage is required to de-ionize the gas and ignit the lamp through a start-up circuit capable of boost voltage. To enable the fluorescent lamp to work stably, this start-up circuit shall be designed delicately.

The flat fluorescent lamp (FFL) is one having external electrodes and emitting a flat form of light source, and it is particularly suitable for the LCD backlight applications since the shortcoming that the general flat fluorescent lamp and the light-emitting diode can not light uniformly. In addition to the better light uniformity, the flat fluorescent lamp also has the following merits, such as a relatively lower cost, a good performance in high and low temperature environments, a prolonged lifetime, an improved color saturation and an easier integration becoming a backlight source module in the LCD backlight applications. In addition, the mercury-free flat fluorescent lamp also has the advantage of zero pollution, making itself more competitive in the current market considerably demanded with the environment protection issue. However, since such flat fluorescent lamp is provided with the external electrodes design and without mercury located therein, the start-up circuit thereof is more difficult to be designed in request of a stable driving ability for the lamp ignition, as compared to that of the traditional mercury-containing fluorescent lamp.

Before the mercury-free flat fluorescent lamp is started up, the lamp can be regarded as a high resistor. To well ignite the flat fluorescent lamp, an input voltage should be boosted to lamp voltage reaching to an ignition level. In the conventional flat fluorescent lamp, a resonance network is used as the start-up circuit and then a sinusoidal voltage is applied to the flat fluorescent lamp and the current flowing through flat fluorescent lamp is also sinusoidal waveform. Although such the voltage boost scheme can provide a start-up voltage to the flat fluorescent lamp, experiments show that a large circulating current is flowing through the flat fluorescent lamp. This extremely circulating current may cause an unnecessary power loss. Hence, the luminous efficiency of the lamp is decreased. Furthermore, the lamp body is heated causing the undesirably higher temperature. Additionally, this extremely circulating energy should be designed as operating a short interval to prevent the unreservedly overloading damage of driving circuit. To overcome this problem, an open protect circuit is necessary to protect the driving circuit when the load lamp is broken or removed.

Typically, the resonant scheme is usually using a variable frequency method resulting in increasing the complexity of the design of the magnetic components, such as transformers and inductors. It is not only increasing the cost of the magnetic components but also the design of these magnetic components cannot design to be optimized. Moreover, since the mercury-free flat fluorescent lamp has a property of with large area, the lamp is not easy to be uniformly and rapidly ignited. In literature, OSRAM Corp. proposes a method to ignite the flat fluorescent lamp by changing a switching frequency of the driving circuit and by using the burst mode dimming technology. Experimental results obtained in this manner are shown in FIG. 1 and FIG. 2. Specifically, the waveform of a lamp current is shown on an upper portion of FIG. 1 and an enlarged diagram of the waveform of the lamp current is shown on a lower portion of FIG. 1. The waveform of a lamp voltage is shown on an upper portion of FIG. 2 and an enlarged diagram of the waveform of the lamp voltage is shown on a lower portion of FIG. 2. Since this method is using the resonance scheme to achieve voltage boost functions, the shortcomings of the high circuiting energy flowing driving circuit, core saturation of the magnetic components, and the load lamp cannot be arranged as an open circuit are presented when performed in this manner. In this method, the lamp cannot be precisely and rapidly ignited since the lamp voltage is boosted by means of the resonance mechanism.

Therefore, it is necessary to develop a driving circuit and driving method for the fluorescent lamp of any kinds, particularly the mercury-free fluorescent lamp, so that the fluorescent lamp such as the mercury-free fluorescent lamp may be precisely and rapidly started up and thus employed in the LCD and other lighting equipment.

In this regard, the inventors of the application has been involved in a series of intensive research, experiments and tests and finally sets forth a driving circuit and method for a fluorescent lamp in the present invention, with which the shortcomings existing in the prior art can be overcome.

### SUMMARY OF THE INVENTION

It is, therefore, an object of the present invention to provide a driving circuit and method for a fluorescent lamp which can overcome the shortcomings existing in the prior art.

In accordance with an aspect of the present invention, the circuit for driving a fluorescent lamp is disclosed, which comprises a power factor correction (PFC) stage receiving an alternating current (AC) voltage and adjusting the AC voltage into a direct current (DC) voltage, a start-up stage receiving the DC voltage and boosting the DC voltage to be an operating voltage, an isolation stage, a square-wave driving stage being isolated with the PFC stage via the isolation stage and adjusting the operating voltage into a boosted voltage when the operating voltage reaches a start-up voltage, and an output stage receiving the boosted voltage and boosting the square-wave voltage into a boosted square-wave voltage and igniting the fluorescent lamp by using the boosted square-wave voltage, wherein the square-wave driving stage is initialized and the start-up stage is stopped when the operating voltage reaches the start-up voltage.

In an embodiment, the start-up stage is one of a voltage boost converter and a fly-back converter.

In an embodiment, the fly-back converter is one of a Cuk converter, a single-ended primary inductor circuit (SEPIC) converter and a Zeta converter.

In an embodiment, the square-wave driving stage is connected in parallel with the start-up stage.

In an embodiment, the square-wave driving stage is one of a half-bridge driving circuit, a full-bridge driving circuit and a push-pull circuit.

In an embodiment, the fluorescent lamp is one of a non-flat fluorescent lamp and a flat fluorescent lamp. In a further embodiment, the flat fluorescent lamp is one of a mercury-containing flat fluorescent lamp and a mercury-free flat fluorescent lamp.

In accordance with another aspect of the present invention, a method for driving a fluorescent lamp is disclosed, which comprises the steps of generating a direct current (DC) voltage, boosting the DC voltage to be an operating voltage according to a pulse-wave input, stopping the pulse-wave input and converting the operating voltage to a boosted voltage when the operating voltage reaches a start-up voltage, and igniting the fluorescent lamp by using the boosted voltage.

In an embodiment, the fluorescent lamp is one of a non-flat fluorescent lamp and a flat fluorescent lamp. In a further embodiment, the flat fluorescent lamp is one of a mercury-containing flat fluorescent lamp and a mercury-free flat fluorescent lamp.

With use of the driving circuit and method of the present invention, the large circulating current issue can be eliminated. Further, the start-up stage has a shortened processing time and requires a less processing energy, which associates with smaller components in the start-up stage. Accordingly, the purposes of compactness and lightweight as well as lower cost component may be adopted.

Other objects, advantages and efficacies of the present invention will be described in detail below taken from the preferred embodiments with reference to the accompanying drawings.

### BRIEF DESCRIPTION OF THE DRAWINGS

The foregoing summary, as well as the following detailed description of the preferred embodiments, is better understood when read in conjunction with the appended drawings. It is understood, however, that the invention is not limited to the specific methods disclosed or illustrated. In the drawings:

FIG. 1 is an experimental waveform of a lamp current of a prior art fluorescent lamp using burst mode dimming technique;

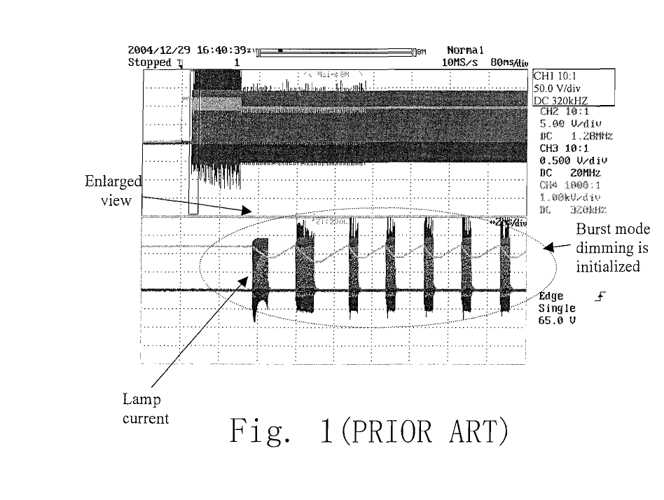

FIG. 2 is an experimental waveform of a lamp voltage of a prior art fluorescent lamp using frequency varying technique;

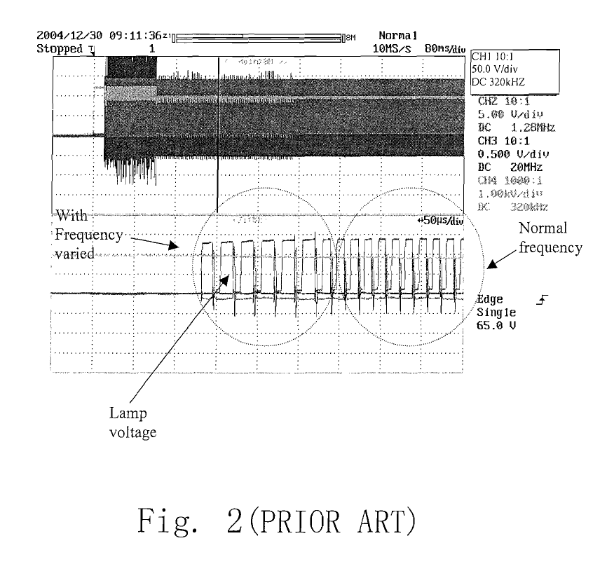

FIG. 3 is a functional block diagram of a driving circuit of a fluorescent lamp according to the present invention;

FIG. 4 is a schematic view of the driving circuit of a fluorescent lamp according to a first embodiment of the present invention;

FIG. 5 is a signal waveform plot associated with the driving circuit shown in FIG. 3;

FIG. 6 is a schematic view of the driving circuit of a fluorescent lamp according to a second embodiment of the present invention;

FIG. 7 is a flowchart illustrating a method for driving a fluorescent lamp according to the present invention; and

FIG. 8 is an experimental waveform of a lamp current of a fluorescent lamp applied with the burst mode dimming technique according to the present invention.

### DETAILED DESCRIPTION OF THE PREFERRED EMBODIMENT

The present invention discloses a driving circuit and method for a fluorescent lamp, particularly a mercury-free flat fluorescent lamp, which will be described through the preferred embodiments in conjunction with the appended drawings.

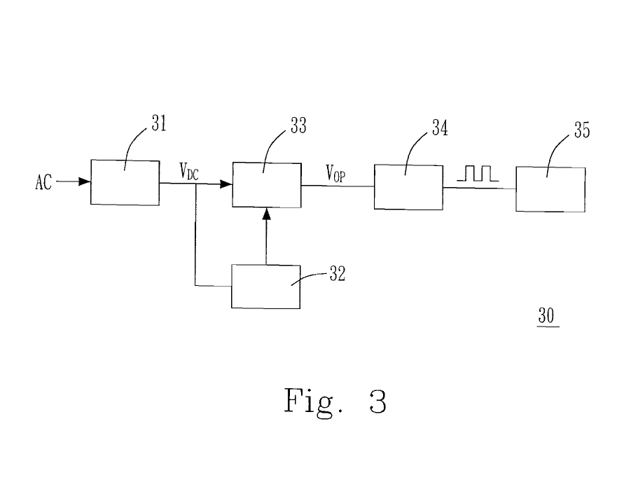

FIG. 3 shows a functional block diagram of the driving circuit for a fluorescent lamp according to the present invention. As shown, the driving circuit 30 comprises a power factor correction (PFC) stage 31, a start-up stage 32, an isolation stage 33, a square-wave driving stage 34 and an output stage 35. The PFC stage 31 receives an alternating current (AC) voltage and generates a direct current (DC) voltage V_{DC}. The start-up stage 32 boosts the DC voltage V_{DC} into a predetermined start-up voltage and provides an operating voltage Vₒₚ. The isolation stage 33 is connected between the start-up stage 32 and the square-wave driving stage 34, so that the two stages 32, 34 are isolated from each other. Accordingly, the start-up stage 32 does not interfere with the other elements in the driving circuit 30. At the square-wave driving stage 34, the operating voltage Vₒₚ is converted into a square-wave voltage. Upon receiving the square-wave voltage, the output stage 35 drives the florescent lamp to be ignited.

In the above, the PFC stage 31 has a capacitor for storing the DC voltage V_{DC}. In boosting the DC voltage V_{DC}, a pulse-wave voltage is inputted to and triggers the start-up stage 32. The isolation stage 33 may be any one of a diode, a capacitor, a resistor, an inductor and an isolating transformer. Between the square-wave driving stage 34 and the output stage 35, a voltage transforming and coupling device is provided in a manner that the square-wave voltage is transformed into a boosted square-wave voltage and coupled to an internal resistance of the fluorescent lamp. In this manner, the fluorescent lamp is ignited.

In the square-wave driving stage 34, there is a small capacitor. When the operating voltage Vₒₚ is equal to the start-up voltage V_{Boost}, i.e. the small capacitor is charged completely, the square-wave driving stage 34 is stopped. In addition, the fluorescent lamp is one of a non-flat fluorescent lamp and a flat fluorescent lamp. In a further embodiment, the flat fluorescent lamp is one of a mercury-containing flat fluorescent lamp and a mercury-free flat fluorescent lamp.

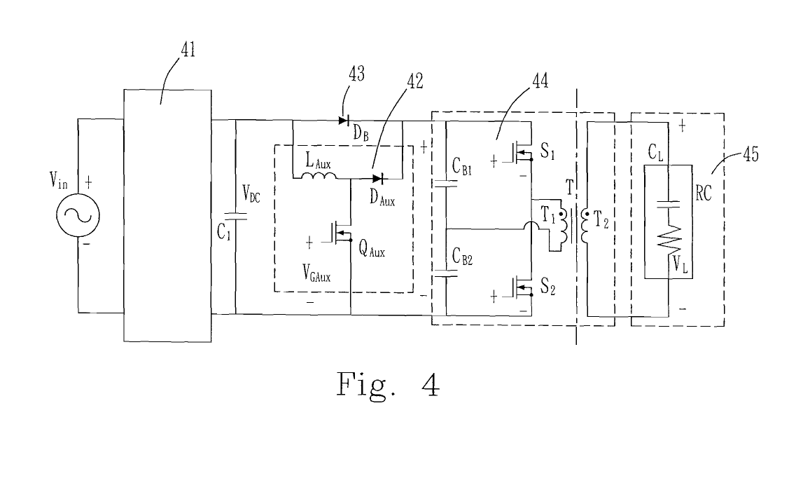

Referring to FIG. 4, the driving circuit for a fluorescent lamp according to a first embodiment of the present invention is schematically shown therein. As shown in the driving circuit 40, the PFC stage 41 comprises a capacitor C1 for storing the DC voltage V_{DC} generated from the PFC stage 41. The start-up stage 42 is a voltage boost circuit and comprises a diode D_{AUX}, an inductor L_{AUX} and an NMOS transistor Q_{AUX}. The inductor L_{AUX} is electrically connected to one end of the NMOS transistor Q_{AUX} at one end and a positive end of the diode D_{AUX} at the other end. The other end of the NMOS transistor Q_{AUX} is electrically connected to ground. The voltage boost circuit is herein termed as a “voltage boost circuit” since there is no isolating element provided therein. The square-wave driving stage 44 is electrically connected in series with the start-up stage 42. The isolation stage 43 may be a blocking diode D_{B}, and may also be any one of a diode, a capacitor, a resistor, an inductor and an isolating diode D_{B}. The square-wave driving stage 34 is composed of a half-bridge driving circuit and a primary side T1 of a transforming device T, on the primary side T1 the square-wave voltage exists. The output stage 45 is composed of a load lamp (physically a RC unit RC composed of one or more resistor and one or more capacitor) and a secondary side T2 of the transforming device T. In an embodiment, the RC unit RC includes a load capacitor set C_{L} and a load resistor set R_{L}, wherein the load resistor set R_{L} is the internal resistance of the fluorescent lamp, and each of the load capacitor set C_{L} and the load resistor set R_{L} includes one or more capacitor and one or more resistor, respectively.

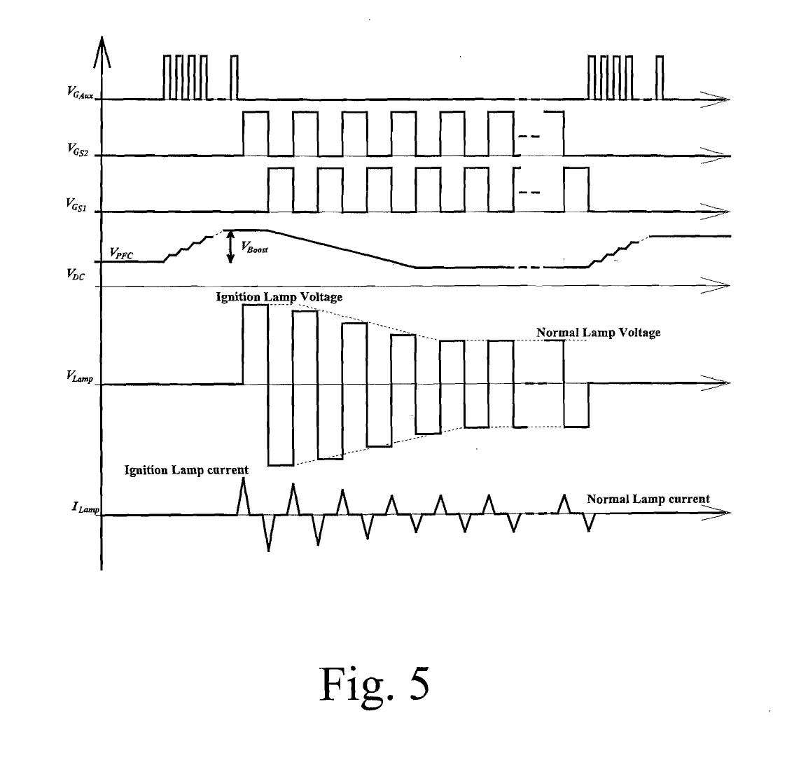

Waveforms of signals associated with the driving circuit described above experimentally obtained are provided in FIG. 5. As shown, when a pulse-wave voltage V_{GAux} is inputted to the NMOS transistor Q_{Aux} in the start-up stage 42, the operating voltage Vₒₚ is increased rapidly. When the operating voltage Vₒₚ increases to the predetermined boosted voltage V_{Boost}, the pulse-wave voltage V_{GAux} is stopped while two capacitors C_{B1} and C_{B2} in the square-wave driving stage 44 are completely charged. Next, two NMOS transistors S1 and S2 of the half-bridge circuit 44 are respectively inputted with a square-wave voltage at its respective gate. When transmitted to the transformer T, the boosted voltage is transformed into a boosted square-wave voltage and coupled to the output stage 45. At this time, a voltage component of the boosted square-wave voltage is presented across the load resistor set R_{L} as a lamp voltage Vₗₐₘₚ and thus the fluorescent lamp is ignited. It is to be noted that the lamp current Iₗₐₘₚ is at this time formed as having a train of spikes. Since the start-up stage 42 is shut off when the start-up voltage V_{Boost} is reached, the operating voltage Vₒₚ decreases continuously until it is equal to the voltage V_{DC} on the storage C1. When a next pulse-wave voltage is inputted to the transistor Q_{Aux}, the process described above is repeated.

In the above, the start-up voltage V_{Boost} is approximately 1.5 times of V_{PFC} and the lamp voltage V_{Lamp} is approximately 1.5 to 2 kV The moment when the NMOS transistor V_{Gaux} is turned off is dependent on the capacitance values of the capacitors C_{B1} and C_{B2}. Specifically, upon being charged completely of the capacitors C_{B1} and C_{B2}, the pulse-wave input to the NMOS transistor V_{Gaux} is stopped. That means the capacitance values of the capacitors C_{B1} and C_{B2} should be selected according to the start-up voltage V_{Boost}, and the moment when the NMOS transistor V_{Gaux} is turned off should be appropriately selected. Alternatively, the pulse-wave input may be stopped automatically. In this case, only a simple circuit is required to control a trigger signal to be issued to trigger the pulse-wave input to be stopped at the moment when the capacitors C_{B1} and C_{B2} are charged completely. This simple circuit is apparent to those persons skilled in the art and will be omitted for clarity reason.

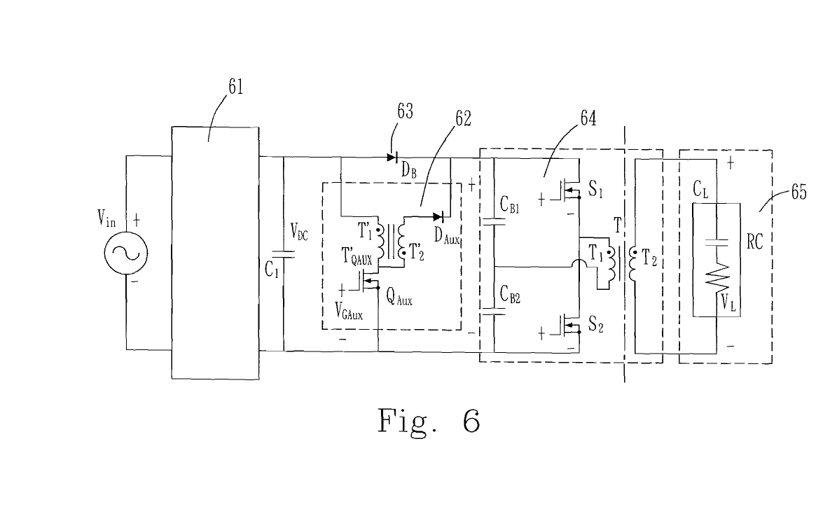

Referring to FIG. 6, the driving circuit for a fluorescent lamp according to the second embodiment of the present invention is schematically shown therein. In the driving circuit 60, the stages 61, 63, 64 and 65 are identical to the corresponding stages 41, 43, 44 and 45 used in the above embodiment while the start-up stage 62 is different from the start-up circuit 42 used in the above embodiment. The start-up stage 62 is also a voltage flyback circuit and comprises a transformer T′, a diode D_{Aux} and an NMOS transistor Q_{Aux}. The transformer T′_{Aux} is electrically connected to a positive end of the diode D_{Aux} at its secondary side T2′ and one end of the NMOS transistor Q_{Aux} at its primary side in series. The other end of the NMOS transistor Q_{Aux} is connected to ground. Herein, the voltage boost circuit has an isolating transformer T′_{Aux} and is thus termed as a “fly-back circuit” or an “isolating voltage boost/buck circuit”. As to the signal waveforms associated with this embodiment, they are identical to that shown in FIG. 5 and thus omitted herein.

In addition to the above embodiments, the voltage boost circuit in the start-up stage may also be replaced with a Cuk converter, a single-ended primary inductor circuit (SEPIC) converter, a Zeta converter and the like, as long as it may provide a voltage boosted function. In addition, the square-wave driving stage may also be composed of a suitable circuit other than the half-bridge circuit, such as a full-bridge circuit and a pull-push circuit, as long as it may adjust the DC operating voltage into the boosted square-wave voltage for driving the fluorescent lamp.

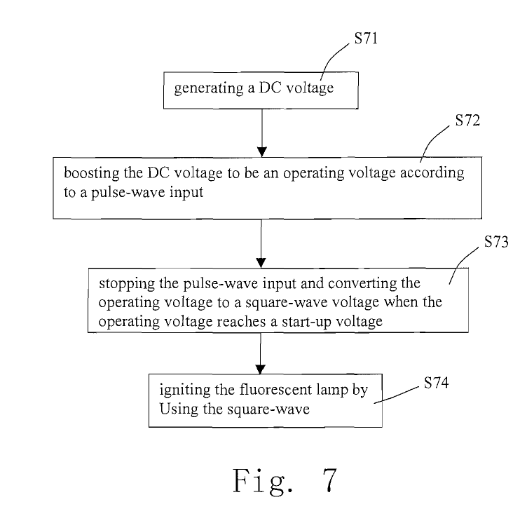

Referring to FIG. 7, a flowchart illustrating the driving method for a fluorescent lamp is provided therein. As shown, the method for driving a fluorescent lamp comprises the following steps. At first, a DC voltage is generated (S71). Next, the DC voltage is boosted to be an operating voltage according to a pulse-wave input (S72). Thereafter, the pulse-wave input is stopped and the operating voltage is converted to a boosted voltage when the operating voltage reaches a start-up voltage (S73). Then, the fluorescent lamp is ignited by using the boosted voltage.

In an embodiment, the step S71 comprises the step of receiving an AC voltage and converting the AC voltage into the DC voltage by using such as a PFC circuit. The step S74 comprises the step of adjusting the boosted voltage into a final boosted square-wave voltage and igniting the fluorescent lamp by using the final boosted square-wave voltage.

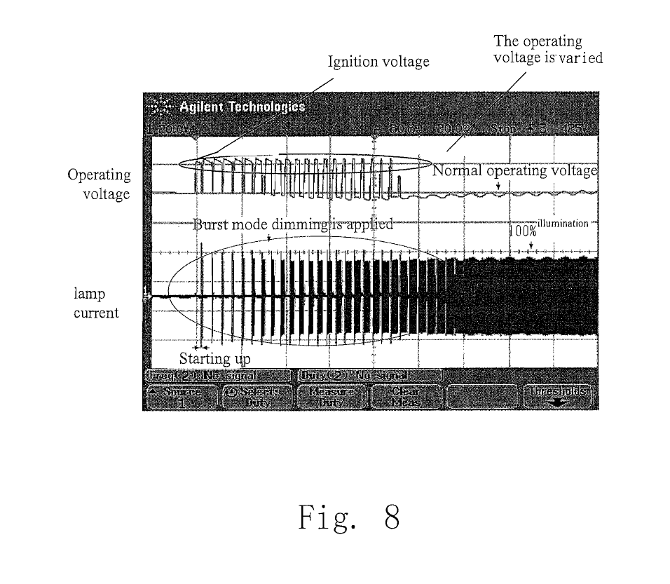

In addition, the driving method as mentioned above may also be performed with the burst mode dimming technology applied. It may be known through FIG. 8 in which experimental results, including the operating voltage and the lamp current, are shown, that the lamp body is easy to be ignited when the operating voltage associated with the square-wave driving stage is controlled to be greater than a normal value. Accordingly, the light emitted from the lamp body can be presented as little as possible without flickering occurring.

It is to be noted that the start-up circuit, the driving circuit and method of the invention may be particularly and advantageously used in the mercury-free flat fluorescent lamp, especially the flat fluorescent lamp, which is considered the most difficult to be stably driven. Since the mercury-free fluorescent lamp can be properly driven to work, it may be used in liquid crystal display (LCD) as a backlight source, thereby achieving the purposes of uniform illumination and zero pollution.

By using this invention, since it is possible to drive the fluorescent lamp with the square-wave voltage and rapidly obtain the boosted DC voltage from the input DC voltage in the start-up stage with the stage shut off immediately when the boosted DC voltage is reached. Further, the start-up stage has a shortened processing time and requires a less processing energy, which associates with smaller components in the start-up stage. Accordingly, the purposes of compactness and lightweight as well as lower component cost may be achieved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for driving a fluorescent lamp, comprising the steps of:
generating a direct current (DC) voltage;
boosting the DC voltage to be an operating voltage according to a pulse-wave input;
stopping the pulse-wave input and converting the operating voltage to a boosted voltage when the operating voltage reaches a start-up voltage; and
igniting the fluorescent lamp by using the boosted voltage.

2. The method according to claim 1, wherein the step of generating comprising the step of:
receiving an alternating current (AC) voltage; and
converting the AC voltage into the DC voltage by using a power factor correction (PFC) circuit.

3. The method according to claim 1, wherein the step of igniting comprises the steps of:
adjusting the boosted voltage into a final boosted voltage; and
igniting the fluorescent lamp by using the final boosted voltage.

4. The method according to claim 1, wherein the fluorescent lamp is one of a non-flat fluorescent lamp and a flat fluorescent lamp.

5. The method according to claim 4, wherein the flat fluorescent lamp is one of a mercury-containing flat fluorescent lamp and a mercury-free flat fluorescent lamp.

6. A circuit for driving a fluorescent lamp, comprising:
a power factor correction (PFC) stage receiving an alternating current (AC) voltage and adjusting the AC voltage into a direct current (DC) voltage;
a start-up stage receiving the DC voltage and boosting the DC voltage to be an operating voltage;
an isolation stage;
a square-wave driving stage being isolated from the PFC stage with the isolation stage and adjusting the operating voltage into a boosted voltage when the operating voltage reaches a start-up voltage; and
an output stage receiving and boosting the square-wave voltage into a boosted square-wave voltage and igniting the fluorescent lamp by using the boosted square-wave voltage,
wherein the square-wave driving stage is initialized and the start-up stage is stopped when the operating voltage reaches the start-up voltage.

7. The circuit according to claim 6, wherein the PFC stage comprises a capacitor for storing the DC voltage.

8. The circuit according to claim 6, wherein the start-up stage is one of a voltage boost converter and a fly-back converter.

9. The circuit according to claim 8, wherein the fly-back converter is one of a Cuk converter, a single-ended primary inductor circuit (SEPIC) converter and a Zeta converter.

10. The circuit according to claim 6, wherein the square-wave driving stage is connected in parallel with the start-up stage.

11. The circuit according to claim 10, wherein the isolation stage is selected from the group consisting of a diode, a capacitor, a resistor, an inductor and an isolating transformer.

12. The circuit according to claim 6, wherein the square-wave driving stage is selected from the group consisting of a half-bridge driving circuit, a full-bridge driving circuit and a push-pull circuit.

13. The circuit according to claim 6, wherein the square-wave driving stage comprises a low voltage side of a transformer on which the square voltage exists and the output stage comprises a high voltage side of the transformer receiving and coupling the boosted square-wave voltage into a transformed square-wave voltage and a resistance and capacitance unit through which the fluorescent lamp is ignited.

14. The circuit according to claim 13, wherein the resistance and capacitance unit comprises a load resistor set being an internal resistance of the fluorescent lamp and a load capacitor set connected in series therewith.

15. The circuit according to claim 14, wherein the load resistor set comprises a load resistor.

16. The circuit according to claim 14, wherein the load capacitor set comprises a load capacitor.

17. The circuit according to claim 6, wherein the fluorescent lamp is one of a non-flat fluorescent lamp and a flat fluorescent lamp.

18. The circuit according to claim 17, wherein the planar fluorescent lamp is one of a mercury-containing flat fluorescent lamp and a mercury-free flat fluorescent lamp.

19. A circuit for driving a fluorescent lamp, comprising:
direct current (DC) voltage generating unit receiving an alternating current (AC) generating and generating a DC voltage;
DC voltage boosting unit receiving a pulse-wave input boosting the DC voltage into an operating voltage according to the pulse-wave input;
pulse-wave input stopping unit stopping the pulse-wave input when the operating voltage reaches a start-up voltage;
square-wave voltage generating unit converting the operating voltage to a boosted voltage when the operating voltage reaches the start-up voltage; and
lamp igniting unit igniting the fluorescent lamp by using the boosted voltage.

20. The circuit according to claim 19, wherein the DC voltage generating unit and the square-wave voltage generating unit are isolated with an isolating unit.
